(19) United States
(12) Patent Application Publication
(10) Pub. No.: US 2010/0211769 A1
(43) Pub. Date: Aug. 19, 2010

(54) Concurrent Execution of a Smartphone Operating System and a Desktop Operating System

(76) Inventors: Subramonian Shankar, Norcross, GA (US); Subash Kalbarga, Suwanee, GA (US); Sanjoy Maity, Snellville, GA (US)

Correspondence Address: HOPE BALDAUFF HARTMAN, LLC;Michael J. Baldauff, Jr., 1720 PEACHTREE STREET, N.W, SUITE 1010, ATLANTA, GA, 30309, US

(21) Appl. No.: 12/706,392

(22) Filed: Feb. 16, 2010

Related U.S. Application Data
(60) Provisional application No. 61/153,779, filed on Feb. 19, 2009.

(51) Int. Cl. G06F 9/24; G06F 9/455; G06F 9/445; G06F 17/30

(52) U.S. Cl. 713/2; 718/1; 717/174; 707/621; 707/E17.005

(57) ABSTRACT

A non-smartphone computing system, such as a laptop or desktop personal computer, can be booted into either or both a smartphone operating system and a desktop operating system. The smartphone operating system may be booted first to allow use of the functionality provided by the smartphone operating system while the desktop operating system is booting. Through an appropriate user action, such as the selection of a pre-defined key, key sequence, or by use of a switch, the computing system can dynamically switch between the smartphone operating system and the desktop operating system. Files and folders can also be synchronized and/or shared between the smartphone operating system and the desktop operating system, thereby providing access to these files from each respective operating system even while the other operating system is not executing.

### CROSS-REFERENCE TO RELATED APPLICATIONS

This application claims the benefit of U.S. provisional patent application No. 61/153,779, filed on Feb. 19, 2009, which is expressly incorporated herein by reference in its entirety.

### BACKGROUND

A smartphone is a wireless mobile telephone that offers some personal computer (PC)-like functionality. For instance, some smartphones include functionality for sending and receiving electronic mail (“e-mail”) messages, browsing the World Wide Web (“Web”), and for maintaining an electronic calendar. Some smartphones also provide functionality for running other first party applications (e.g. those provided by the smartphone manufacturer) and third party applications.

While the current generation of smartphones provides significant functionality, these devices also suffer from several drawbacks. As an example, the user input mechanisms utilized on current smartphones are often frustrating to use. For instance, some smartphones have small keyboards that can be difficult to type on. Other smartphones have no keyboard at all and instead utilize a touch screen interface that can also be frustrating. As another example, the small screen size utilized by most smartphones can be limiting in terms of the amount of information that can be displayed and may even be difficult for some users to read.

It is with respect to these and other considerations that the disclosure presented herein has been made.

### SUMMARY

The following disclosure is directed to concepts and technologies for concurrent execution of a smartphone operating system and a desktop operating system on a non-smartphone device. For instance, utilizing the technologies presented herein, a smartphone operating system can be utilized on non-smartphone hardware, such as a standard notebook, netbook, or desktop computer.

By executing a smartphone operating system on non-smartphone hardware in the manner presented herein, a robust operating environment provided by the smartphone operating system may be quickly enabled for use by a computer user. The smartphone operating system can be loaded much more quickly and provide better battery life than a traditional desktop operating system, while still providing significant functionality such as, for instance, playing movie or audio files, checking e-mail messages, or browsing the Web. According to various embodiments presented herein, a user may utilize first-party and third-party smartphone applications executing on the smartphone operating system while at the same time enjoying the benefits of the non-smartphone hardware, such as a larger keyboard, larger display, full size user input devices, and the like.

According to aspects presented herein, technologies are also provided for allowing a user to boot the non-smartphone hardware, such as a standard laptop or personal computer, into either a smartphone operating system or a desktop operating system. In one embodiment, both the smartphone operating system and the desktop operating system may be booted concurrently. In another embodiment, the smartphone operating system is booted first to thereby allow the user to utilize functionality provided by the smartphone operating system while the desktop operating system is booting. The functionality provided by the smartphone operating system can be utilized while the desktop operating system is booting.

According to embodiments, a virtualization layer is provided to execute the smartphone operating system and the desktop operating system in virtual machines. Through an appropriate user action, such as the selection of a pre-defined key, key sequence, or by use of a switch, the computing system can dynamically switch between the smartphone operating system and the desktop operating system. Moreover, files and folders can be synchronized and/or shared between the smartphone operating system and the desktop operating system, thereby providing access to these files in each respective operating system even while the other operating system is not executing.

It should be appreciated that the above-described subject matter may also be implemented as a computing system, a computer-controlled apparatus, a computer process, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computer software and hardware architecture diagram showing an illustrative operating environment along with several software components provided in embodiments disclosed herein;

FIG. 2 is a block diagram showing aspects of one implementation disclosed herein for synchronizing data between a smartphone operating system and a desktop operating system;

FIG. 3 is a flow diagram showing one illustrative process presented herein for concurrently executing a smartphone operating system and a desktop operating system; and

FIG. 4 is a computer architecture diagram showing an illustrative computer architecture that might be utilized to implement a computing system that embodies the various concepts and technologies presented herein.

### DETAILED DESCRIPTION

The following detailed description is directed to technologies for executing a smartphone operating system and a desktop operating system on non-smartphone hardware. While the subject matter described herein is presented in the general context of program modules that execute in conjunction with the execution of an operating system and application programs on a computer system, those skilled in the art will recognize that other implementations may be performed in combination with other types of program modules.

Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following description, references are made to the accompanying drawings that form a part hereof, and which are shown by way of illustration specific embodiments or examples. Referring now to the drawings, in which like numerals represent like elements throughout the several figures, aspects of a computing system and methodology for concurrent execution of a smartphone operating system and a desktop operating system on a non-smartphone device will be described.

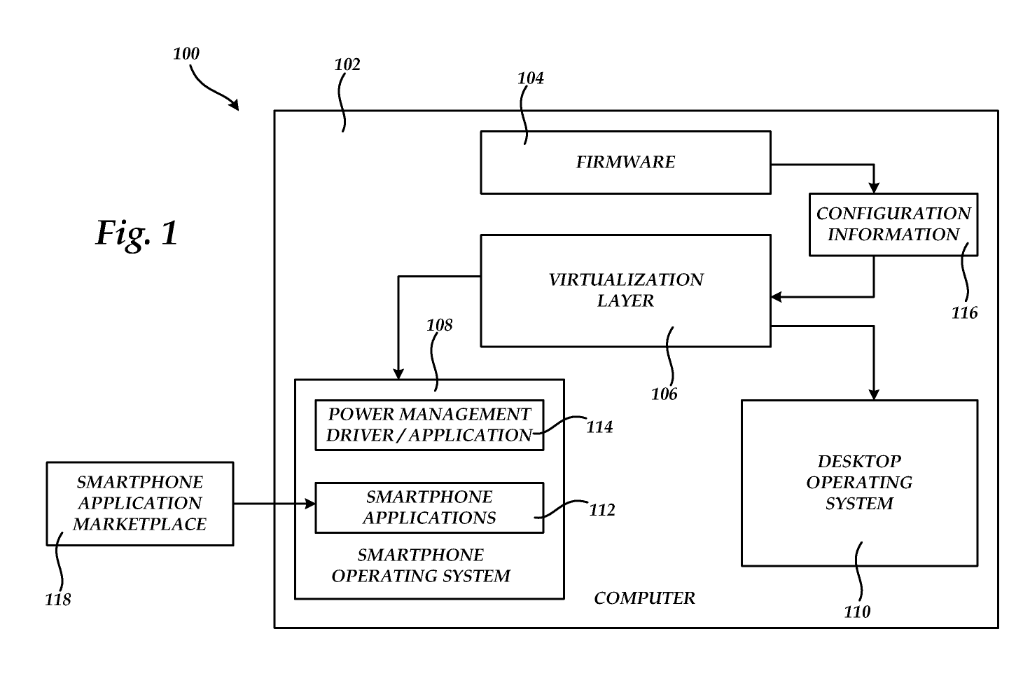

Turning now to FIG. 1, details will be provided regarding an illustrative operating environment and several software components provided by the embodiments presented herein. In particular, FIG. 1 shows aspects of a system 100 for executing a smartphone operating system 108 and a desktop operating system 110 on a non-smartphone device, such as the computer 102. In one embodiment the computer 102 comprises a standard laptop or desktop computing system capable of executing a desktop operating system 110. As will be described in greater detail below, the computer 102 is also configured in embodiments disclosed herein to execute a smartphone operating system 108 even though the smartphone operating system 108 is not generally intended for execution on the computer 102. In this manner, the computer 102 can be enabled to mimic the operation of a smartphone, while at the same time retaining the ability to execute a desktop operating system 110.

In mimicking a smartphone, the computer 102 provides many of the functions of a smartphone running smartphone software, including the smartphone operating system 108 and smartphone applications 112 which may be first party or third-party applications. This allows the computer 102 to mimic a standard smartphone including much of the functionality provided by a smartphone including functionality provided by the applications 112. This functionality is provided in addition to the standard functionality provided by the computer 102 through the execution of the desktop operating system 110.

As will also be discussed in greater detail below, the computer 102 is configured in embodiments to concurrently execute the smartphone operating system 108 and the desktop operating system 110. According to aspects, a user of the computer 102 can switch back and forth between the operation of the smartphone operating system 108 and the desktop operating system 110. Additionally, folders and files can be shared between the smartphone operating system 108 and the desktop operating system 110 even while one operating system is not executing. Additional details regarding these features of the computer 102 as provided herein will be described below.

As described briefly above, the computer 102 comprises a standard notebook, laptop, or desktop computing system capable of executing a desktop operating system 110. It should be appreciated, however, that the computer 100 may comprise other types of computing devices, including a multimedia internet device (“MID”), a netbook, or other type of non-smartphone small form factor computing device. It should also be appreciated that the desktop operating system 110 may be any operating system configured for providing full functionality to a desktop or laptop computing system. For example, according to embodiments, the desktop operating system 110 may comprise one of the WINDOWS family of operating systems from MICROSOFT CORPORATION, the OSX operating system from APPLE COMPUTER, INC., the LINUX operating system, or another type of desktop operating system known in the art. In this regard, the computer 102 provides functionality for booting and executing the desktop operating system 110 in a conventional manner.

As also described briefly above, the computer 102 provided herein also provides functionality for executing a smartphone operating system 108. The smartphone operating system 108 comprises an operating system configured for execution on a smartphone device. As described briefly above, a smartphone is a wireless mobile telephone offering advanced capabilities beyond a typical mobile telephone, often with computer-like functionality. Some smartphones may include functionality for receiving and sending e-mail messages, browsing the Web, playing audio and video files, playing computer games and for performing other functions. A non-smartphone device is a computing device capable of performing the functionality disclosed herein that is not a smartphone.

Smartphones typically include relatively small screens and may include a number of user input devices, such as a small keyboard and/or a touch screen. The smartphone operating system 108 may comprise the SYMBIAN OS from SYMBIAN LIMITED, the IPHONE OS from APPLE INC., the RIM BLACKBERRY operating system from RESEARCH IN MOTION, INC., the WINDOWS MOBILE operating system from MICROSOFT, the PALM OS, or the PALM PRE WEBOS developed by PALM, INC., or the ANDROID smartphone operating system from GOOGLE, INC. Other smartphone operating systems may also be utilized in the manner presented herein.

In order to execute the smartphone operating system 108 on the computer 102, a virtualization layer 106 is utilized in one embodiment. As known in the art, virtualization may be utilized to implement a certain kind of virtual machine environment that provides a simulation of the underlying hardware. In this manner, the smartphone operating system can be executed by the virtualization layer 106 even though the smartphone operating system 108 has not been specifically written to execute on the hardware of the computer 102.

According to embodiments, selective virtualization may be utilized by the virtualization layer 106 to virtualize only portions of the hardware required by the smartphone operating system 108. For instance, in one implementation the smartphone operating system 108 is stored in a non-volatile memory of the computer 102. In this example, it would be unnecessary to virtualize a hard disk drive connected to the computer 102 because the functionality provided by the hard disk drive is not required or utilized by the smartphone operating system 108. It should be appreciated that other hardware components of the computer 102 might also be selectively virtualized in a similar manner.

It should be appreciated that the virtualization layer 106 may be stored on a mass storage device of the computer 102 and executed therefrom. Alternatively, the virtualization layer 106 may be implemented within the firmware 104 of the computer 102 and stored in a non-volatile memory of the computer 102. For instance, in one implementation the virtualization layer 106 is executed as part of a BIOS or Extensible Firmware Interface (“EFI”) firmware of computer 102. Other implementations may also be apparent to those skilled in the art.

According to one embodiment, a user of the computer 102 may be prompted for configuration information 116 that indicates how the computer 102 should be booted. According to aspects, the computer 102 may be booted directly into the desktop operating system 110 in a traditional fashion. Alternately, the computer 102 may be booted directly into the smartphone operating system 108 through the use of the virtualization layer 106, described above. In this manner, a user of the computer 102 can specify which of the operating systems 108 or 110 that should be utilized to boot the computer 102.

According to another embodiment, a user of the computer 102 may specify that both the smartphone operating system 108 and the desktop operating system 110 be booted at the same time. In order to perform this process, the virtualization layer 106 is utilized to execute both the smartphone operating system 108 and the desktop operating system 110 in virtual machines. In this manner, both of the operating systems 108 and 110 can be executing concurrently on the computer 102. In one embodiment, a predefined key sequence or other form of user input may be received from a user of the computer 102 in order to switch the display of the computer 102 from the video output of the smartphone operating system 108 to the video output of the desktop operating system 110 and back again. In this manner, a user of the computer 102 can alternately utilize both of the operating systems 108 and 110 in a concurrent fashion.

In order to receive the configuration information 116 from a user, a firmware 104 of the computer 102 may present a user interface menu or other type user interface control through which a user of the computer 102 may specify the manner in which the computer 102 should be booted. If the user selects to boot only the desktop operating system 110, then the computer 102 boots the desktop operating system 110 in a conventional fashion. If a user of the computer 102 chooses to boot either the smartphone operating system 108 or both the smartphone operating system 108 and the desktop operating system 110, then the virtualization layer 106 is loaded. The virtualization layer 106, in turn, loads the smartphone operating system 108 and the desktop operating system 110.

According to embodiments, the smartphone operating system 108 may be loaded and made available to a user of the computer 102 prior to loading the desktop operating system 110. Because the smartphone operating system 108 is much smaller in size than the desktop operating system 110, this allows the computer 102 to boot more quickly and allows functions provided by the smartphone operating system 108 to be utilized by a user of the computer 102 even before the desktop operating system 110 has finished loading. In this regard, the virtualization layer 106 may be configured to save the state of the smartphone operating system 108 to a virtual machine image file and to load the virtual machine image file upon the next boot of the computer 102. This process also reduces the time necessary to load the smartphone operating system 108 and make the smartphone operating system 108 available for use by a user of the computer 102.

It should be appreciated that the smartphone operating system 108 provides additional functionality not available in some custom fixed operating systems. For instance, the smartphone operating system 108 allows a user of the computer 102 to install smartphone applications 112, which may be first party or third-party applications. Smartphone applications 112 are applications programmed for execution on the smartphone operating system 108.

According to embodiments, a smartphone application marketplace 118 may be accessed via a wide area network (“WAN”) in order to download and install smartphone applications 112. The smartphone applications 112 may include applications for sending and receiving e-mail messages, for playing movie files, for playing audio files, for browsing the Web, playing games, and for performing many other functions. According to embodiments, one of the smartphone applications 112 is a Voice Over Internet Protocol (“VOIP”) program through which a user of the computer 102 may make and receive phone calls. Additionally, if the computer 102 includes appropriate hardware, a user of the smartphone operating system 108 may be permitted to place and receive telephone calls over a wireless telephone network in a conventional fashion or over a Wi-Fi network.

According to embodiments, a custom power management driver and application program 114 are executed with the smartphone operating system 108. Because the smartphone operating system 108 is programmed for a different hardware configuration then that present in the computer 102, the smartphone operating system 108 may operate in an energy inefficient manner when executed on the computer 102. Accordingly, the power management driver and application program 114 allow the smartphone operating system 108 to interact with power management features provided by the hardware of the computer 102 and to consequently operate in a more energy efficient manner.

The power management driver provides functionality for interacting with the actual hardware of the computer 102 to reduce power consumption while the smartphone operating system 108 is being executed. The power management application allows a user of the computer 102 to set options relating to power management performed by the smartphone operating system 108. In this manner, the computer 102 may be configured to consume less power when executing the smartphone operating system 108 as compared to when the computer 102 is executing the desktop operating system 110. As a result, a user may be able to utilize the computer 102 to execute the smartphone operating system 108 and perform common functions for an extended period of time as compared to when the desktop operating system 110 is executed.

It should be appreciated that the smartphone operating system 108 is generally configured for execution on a smartphone, which typically has a very small display screen. Through the embodiments presented herein, the smartphone operating system 108 can be used on a larger display screen as provided by a laptop or desktop computer. Moreover, when used on a computer having a smaller display screen, such as a netbook, the smartphone operating system 108 may provide a display more suitable for use on a small screen than the desktop operating system 110. This may provide valuable benefits over the execution of the desktop operating system 110, which is generally intended for use on a larger display screen.

It should also be appreciated that by executing the smartphone operating system 108, the computer 102 is enabled to operate in the same manner as a typical smartphone. In this way, a user of the smartphone operating system 108 can utilize the smartphone applications 112 to browse the Web and access data such as contacts, calendar, and other types of data. This process also allows the smartphone applications 112 to access larger mass storage devices available in the computer 102 for archival purposes.

It should be appreciated that although the virtualization layer 106 provides functionality for concurrently executing the smartphone operating system 108 and the desktop operating system 110, the operation of the virtualization layer 106 is invisible to a user of the computer 102. In particular, a user of the computer 102 may be unaware that the virtualization layer 106 is present and executing on the computer 102. In this way, a user may seamlessly switch between the smartphone operating system 108 and the desktop operating system 110 using keyboard input or another appropriate user interface mechanism. As discussed briefly above, the virtualization layer 106 may be stored in a non-volatile memory of the computer 102. Similarly, the smartphone operating system 108 may also be stored in a non-volatile memory of the computer 102 and executed therefrom. Alternatively, the smartphone operating system 108 may be stored on a mass storage device of the computer 102, such as a hard disk drive, and executed therefrom.

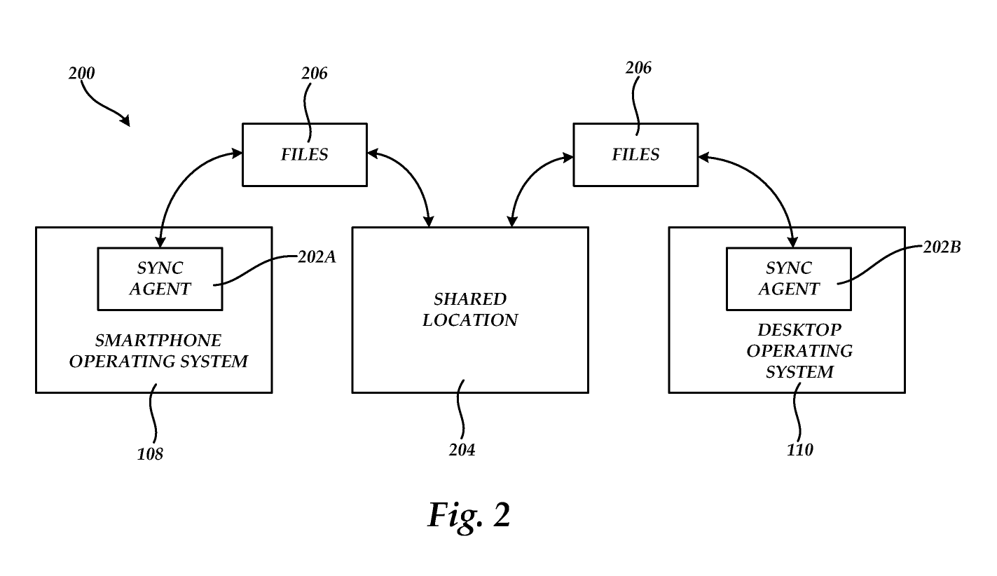

Referring now to FIG. 2, one aspect of the disclosure presented herein for sharing folders and files between the smartphone operating system 108 and the desktop operating system 110 will be described. According to one embodiment, the computer 102 is booted into the desktop operating system 110 upon first boot. When the computer 102 is booted to the desktop operating system 110, a synchronization agent 202B is installed into the desktop operating system 110.

The synchronization agent 202B allows a user of the computer 102 to specify folders or files accessible to the desktop operating system 110 that should be synchronized to a shared location 204. In the example shown in FIG. 2, the files 206 have been identified as files that should be shared between the desktop operating system 110 and the smartphone operating system 108. These files are then copied to the shared location 204 by the synchronization agent 202B. According to embodiments, the synchronization agent 202B may monitor folders or other locations for changes and synchronize the changes to the shared location 204. According to embodiments, the shared location 204 may comprise a location on a mass storage device, such as a hard disk drive, or within a non-volatile memory device. The device upon which the shared location 204 is stored is virtualized for use by the smartphone operating system 108.

As also shown in FIG. 2, the smartphone operating system 108 is also configured in one embodiment with a synchronization agent 202A. The synchronization agent 202A may also be configured in a similar manner to synchronize files from the smartphone operating system 108 to the shared location 204. In the example shown in FIG. 2, the files 206 copied to the shared location 204 by the synchronization agent 202B have been copied to the smartphone operating system 108 by the synchronization agent 202A.

In the manner shown in FIG. 2, two-way synchronization is enabled between the smartphone operating system 108 and the desktop operating system 110. In this way, a user of the computer 102 can access the files 206 from the smartphone operating system 108 even when the desktop operating system 110 is not executing. Similarly, a user of the computer 102 may utilize the desktop operating system 110 to access the files 206 even when the smartphone operating system 108 is not executing.

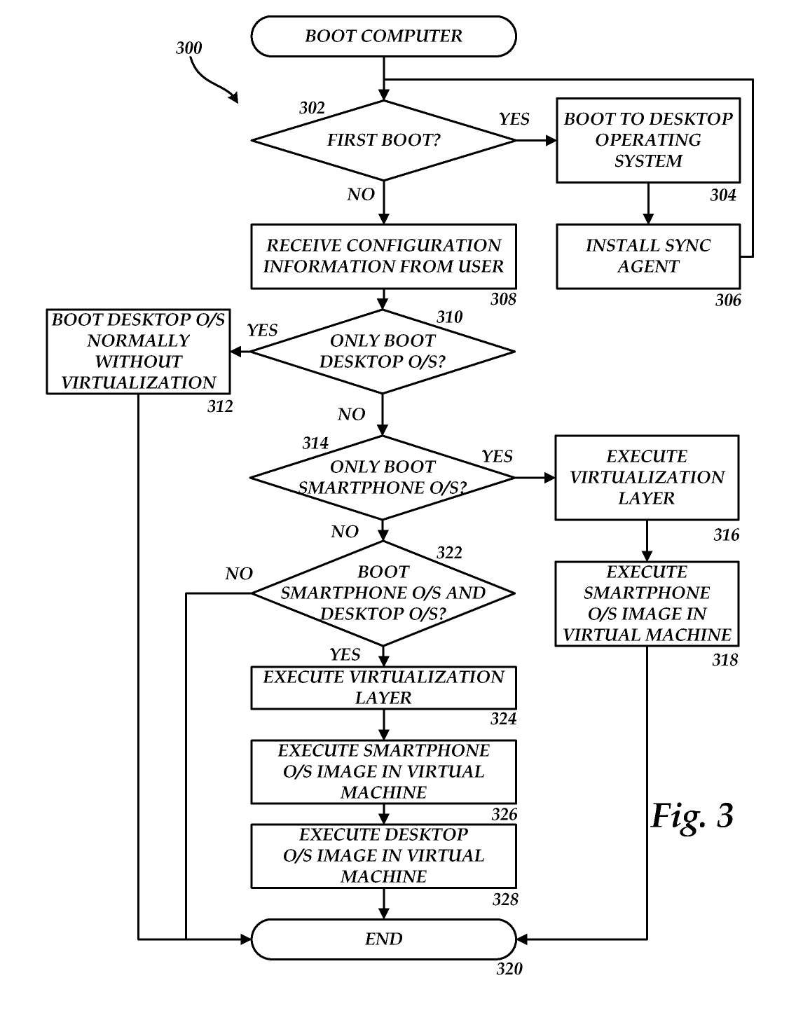

Referring now to FIG. 3, additional details will be provided regarding the embodiments presented herein for a computing system capable of executing a smartphone operating system and a desktop operating system. In particular, FIG. 3 is a flow diagram illustrating aspects of the operation of one process 300 presented herein for booting a computer 102 capable of concurrently executing a smartphone operating system 108 and a desktop operating system 110 in the manner disclosed herein.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 300 begins at operation 302, where the firmware 104 of the computer 102 determines whether the computer 102 is being booted for the first time. If so, the firmware 104 causes the computer 102 to boot the desktop operating system 110 without the use of the virtualization layer 106 at operation 304. Once the computer 102 has been booted using the desktop operating system 110, the synchronization agent 202B is installed onto the desktop operating system 110. This occurs at operation 306. Once the synchronization agent 202B has been installed, the routine 300 proceeds from operation 306 to operation 302. In an alternate embodiment, the synchronization agent 202B is installed in the desktop operating system 110 if it has not previously been installed therein regardless of the number of times the operating system 110 has been previously booted.

If, at operation 302, the firmware 104 of the computer 102 determines that the computer 102 is not being booted for the first time, the routine 300 proceeds from operation 302 to operation 308. At operation 308, the computer 102 receives the configuration information 116 from a user of the computer 102. As discussed above, the firmware 104 of the computer 102 may be configured to prompt a user of the computer 102 for the configuration information 116. As also discussed above, the configuration information 116 is data indicating whether the computer 102 should boot to the desktop operating system 110 only, to the smartphone operating system 108 only, or to boot both the desktop operating system 110 and the smartphone operating system 108 concurrently. Once the configuration information 116 has been received, the routine 300 proceeds from operation 308 to operation 310.

At operation 310, a determination is made as to whether the user has requested to boot only the desktop operating system 110. If so, the routine 300 proceeds from operation 310 to operation 312, where the desktop operating system 110 is booted without the use of the virtualization layer 106. The desktop operating system 110 may then be utilized in a conventional fashion.

If, at operation 310, the computer 102 determines that the user has not requested to boot only the desktop operating system 110, the routine 300 proceeds from operation 310 to operation 314. At operation 314, the computer 102 determines whether the user has requested to boot only the smartphone operating system 108. If so, the routine 300 proceeds from operation 314 to operation 316, where the virtualization layer 106 is executed. From operation 316, the routine 300 then proceeds to operation 318, where the virtualization layer loads the smartphone operating system 108. As discussed above, the virtualization layer 106 may store an image of the executing smartphone operating system 108 and load this image at boot time in order to speed the booting of the computer 102.

If, at operation 314, the computer 102 determines that the user has not requested to boot only the smartphone operating system 108, the routine 300 proceeds to operation 322. At operation 322, the computer 102 determines whether a user has requested to boot both the smartphone operating system 108 and the desktop operating system 110 together. If so, the routine 300 proceeds to operation 324, where the virtualization layer 106 is loaded from either a non-volatile memory or from a volatile mass storage device.

Once the virtualization layer 106 has been loaded, the routine 300 proceeds to operation 326 where the smartphone operating system 108 is loaded in the manner described above. As discussed briefly above, in one embodiment the virtualization layer 106 completely loads the smartphone operating system 108 and makes functionality provided by the smartphone operating system 108 available to a user of the computer 102 prior to loading the desktop operating system 110. In other embodiments, the smartphone operating system 108 and the desktop operating system 110 may be loaded concurrently.

From operation 326, the routine 300 proceeds to operation 328, where the desktop operating system 110 is loaded and executed in a virtual machine provided by the virtualization layer 106. As discussed above, when both the smartphone operating system 108 and desktop operating system 110 are executing concurrently, a mechanism may be provided to allow a user of the computer 102 to switch between the two operating systems. From operations 312, 318, and 328, the routine 300 proceeds to operation 320, where it ends.

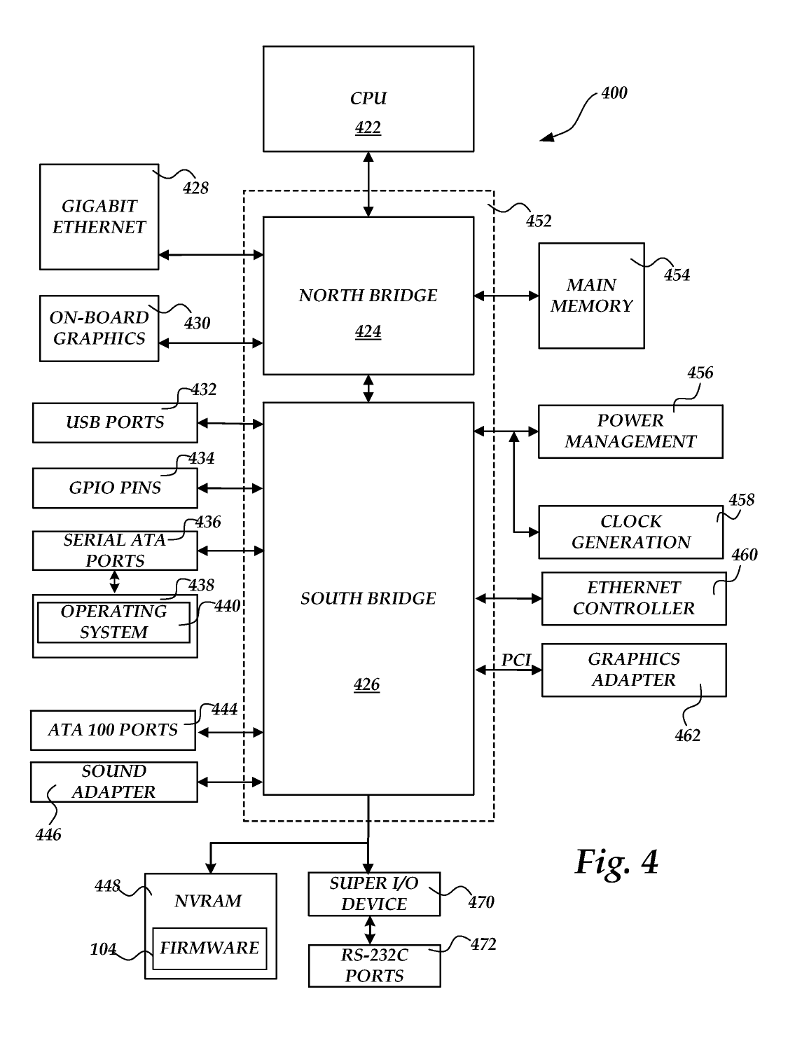

FIG. 4 shows an illustrative computer architecture for a computer 400 that may be utilized in the implementations described herein. The architecture shown in FIG. 4 may be utilized to embody a non-smartphone device such as the computer 102 shown in FIG. 1 and described above.

The computer 400 includes a baseboard, or “motherboard”, which is a printed circuit board to which a multitude of components or devices may be connected by way of a system bus or other electrical communication path. In one illustrative embodiment, a CPU 422 operates in conjunction with a chipset 452. The CPU 422 is a standard central processor that performs arithmetic and logical operations necessary for the operation of the computer. The computer 400 may include a multitude of CPUs 422.

The chipset 452 includes a north bridge 424 and a south bridge 426. The north bridge 424 provides an interface between the CPU 422 and the remainder of the computer 400. The north bridge 424 also provides an interface to a random access memory (“RAM”) used as the main memory 454 in the computer 400 and, possibly, to an on-board graphics adapter 430. The north bridge 424 may also include functionality for providing networking functionality through a gigabit Ethernet adapter 428. The gigabit Ethernet adapter 428 is capable of connecting the computer 400 to another computer via a network. Connections which may be made by the network adapter 428 may include local area network (“LAN”) or wide area network (“WAN”) connections. LAN and WAN networking environments are commonplace in offices, enterprise-wide computer networks, intranets, and the Internet. The north bridge 424 is connected to the south bridge 426.

The south bridge 426 is responsible for controlling many of the input/output functions of the computer 400. In particular, the south bridge 426 may provide one or more universal serial bus (“USB”) ports 432, a sound adapter 446, an Ethernet controller 460, and one or more general purpose input/output (“GPIO”) pins 434. The south bridge 426 may also provide a bus for interfacing peripheral card devices such as a graphics adapter 462. In one embodiment, the bus comprises a peripheral component interconnect (“PCI”) bus, but other types of busses may be utilized.

The south bridge 426 is also operative to provide one or more interfaces for connecting mass storage devices to the computer 400. For instance, according to an embodiment, the south bridge 426 includes a serial advanced technology attachment (“SATA”) adapter for providing one or more serial ATA ports 436 and an ATA 100 adapter for providing one or more ATA 100 ports 444. The serial ATA ports 436 and the ATA 100 ports 444 may be, in turn, connected to one or more mass storage devices storing an operating system 440 and application programs, such as the SATA disk drive 438. As discussed above, an operating system 440 comprises a set of programs that control operations of a computer and allocation of resources. An application program is software that runs on top of the operating system software, or other runtime environment, and uses computer resources to perform application specific tasks desired by the user. As also discussed above, the computer 400 may be configured in the manner described above to execute a smartphone operating system 108, a desktop operating system 110, or both operating systems concurrently.

The mass storage devices connected to the south bridge 426, and their associated computer-readable media, provide non-volatile storage for the computer 400. Although the description of computer-readable media contained herein refers to a mass storage device, such as a hard disk or CD-ROM drive, it should be appreciated by those skilled in the art that computer-readable media can be any available media that can be accessed by the computer 400.

Computer-readable media includes volatile and non-volatile, removable and non-removable media implemented in any method or technology for storage of information such as computer-readable instructions, data structures, program modules or other data. For instance, computer-readable media includes, but is not limited to, RAM, ROM, EPROM, EEPROM, flash memory or other solid state memory technology, CD-ROM, DVD, HD-DVD, BLU-RAY, or other optical storage, magnetic cassettes, magnetic tape, magnetic disk storage or other magnetic storage devices, or any other medium which can be used to store the desired information and which can be accessed by the computer.

A low pin count (“LPC”) interface may also be provided by the south bridge 426 for connecting a “Super I/O” device 470. The Super I/O device 470 is responsible for providing a number of input/output ports, including a keyboard port, a mouse port, a serial interface 472, a parallel port, and other types of input/output ports. The LPC interface may also connect a computer storage media such as a ROM or a flash memory such as a NVRAM 448 for storing the firmware 104 that includes program code containing the basic routines that help to start up the computer 400 and to transfer information between elements within the computer 400. As discussed above, a smartphone operating system 108, a virtualization layer 106, and other program code may also be stored in the NVRAM 448 in embodiments.

It should be appreciated that the computer 400 may comprise other types of non-smartphone computing devices, including hand-held computers, netbooks, MIDs, embedded computer systems, personal digital assistants, and other types of computing devices known to those skilled in the art. It is also contemplated that the computer 400 may not include all of the components shown in FIG. 4, may include other components that are not explicitly shown in FIG. 4, or may utilize an architecture completely different than that shown in FIG. 4.

It should be appreciated that the software components described herein may, when loaded into the CPU 422 and executed, transform the CPU 422 and the overall computer 400 from a general-purpose computing system into a special-purpose computing system customized to facilitate the functionality presented herein. The CPU 422 may be constructed from any number of transistors or other discrete circuit elements, which may individually or collectively assume any number of states. More specifically, the CPU 422 may operate as a finite-state machine, in response to executable instructions contained within the software modules disclosed herein. These computer-executable instructions may transform the CPU 422 by specifying how the CPU 422 transitions between states, thereby transforming the transistors or other discrete hardware elements constituting the CPU 422.

Encoding the software modules presented herein may also transform the physical structure of the computer-readable media presented herein. The specific transformation of physical structure may depend on various factors, in different implementations of this description. Examples of such factors may include, but are not limited to: the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software may also transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 400 in order to store and execute the software components presented herein. It also should be appreciated that the computer 400 may comprise other types of computing devices, including hand-held computers, embedded computer systems, personal digital assistants, and other types of computing devices known to those skilled in the art. It is also contemplated that the computer 400 may not include all of the components shown in FIG. 4, may include other components that are not explicitly shown in FIG. 4, or may utilize an architecture completely different than that shown in FIG. 4.

Based on the foregoing, it should be appreciated that technologies for concurrently executing a smartphone operating system and a desktop operating system are provided herein. Although the subject matter presented herein has been described in language specific to computer structural features, methodological and transformative acts, specific computing machinery, and computer readable media, it is to be understood that the disclosure presented herein is not necessarily limited to the specific features, acts, or media described herein.

The subject matter described above is provided by way of illustration only and should not be construed as limiting. Various modifications and changes may be made to the subject matter described herein without following the example embodiments and applications illustrated and described, and without departing from the true spirit and scope of the disclosure presented herein.

What is claimed is:

1. A computer-implemented method for concurrent execution of a smartphone operating system and a desktop operating system on a non-smartphone device, the method comprising performing computer-implemented operations for:
determining whether the non-smartphone device should be booted using only the desktop operating system, using only the smartphone operating system, or using both the smartphone operating system and the desktop operating system concurrently;
in response to determining that the non-smartphone device should be booted using only the smartphone operating system or using both the smartphone operating system and the desktop operating system concurrently, causing a virtualization layer to be executed on the non-smartphone device;
in response to determining that the non-smartphone device should be booted using only the smartphone operating system, then causing the smartphone operating system to be executed on the non-smartphone device by using the virtualization layer; and
in response to determining that the non-smartphone device should be booted using both the smartphone operating system and the desktop operating system concurrently, then causing the smartphone operating system and the desktop operating system to be executed on the non-smartphone device by using the virtualization layer.

2. The computer-implemented method of claim 1, wherein causing the smartphone operating system and the desktop operating system to be executed on the non-smartphone device by using the virtualization layer comprises booting the smartphone operating system using the virtualization layer completely prior to booting the desktop operating system.

3. The computer-implemented method of claim 2, wherein causing the smartphone operating system and the desktop operating system to be executed on the non-smartphone device by using the virtualization layer further comprises making functionality provided by the smartphone operating system available while the desktop operating system is booted.

4. The computer-implemented method of claim 1, wherein causing the smartphone operating system and the desktop operating system to be executed on the non-smartphone device by using the virtualization layer comprises booting the smartphone operating system and the desktop operating system concurrently using the virtualization layer.

5. The computer-implemented method of claim 3, wherein the smartphone operating system is booted from a previously stored virtual machine image file.

6. The computer-implemented method of claim 5, further comprising:
determining whether the non-smartphone device is being booted for the first time; and
in response to determining that the non-smartphone device is being booted for the first time, causing the non-smartphone device to boot the desktop operating system without the use of the virtualization layer and to cause a synchronization agent to be installed in the desktop operating system.

7. The computer-implemented method of claim 6, wherein the synchronization agent is configured to synchronize files and folders accessible to the desktop operating system to a shared location accessible by the smartphone operating system.

8. The computer-implemented method of claim 7, wherein the smartphone operating system further comprise a second synchronization agent configured to synchronize files and folders accessible to the smartphone operating system to the shared location.

9. The computer-implemented method of claim 8, wherein the shared location is accessible to the smartphone operating system when the desktop operating system is not running and is also accessible to the desktop operating system when the smartphone operating system is not running.

10. The computer-implemented method of claim 9, further comprising executing a power management driver in the smartphone operating system that is configured to provide power management functionality compatible with the non-smartphone device.

11. The computer-implemented method of claim 10, wherein the smartphone operating system is configured to permit the execution of first party and third-party smartphone applications.

12. The computer-implemented method of claim 11, wherein the virtualization layer is configured to perform selective virtualization of hardware of the non-smartphone device for the smartphone operating system.

13. The computer-implemented method of claim 12, wherein the virtualization layer and the smartphone operating system are stored in a non-volatile memory of the non-smartphone device.

14. The computer-implemented method of claim 13, wherein the virtualization layer is implemented in an Extensible Firmware Interface (EFI) firmware of the non-smartphone device.

15. A computer-readable medium having computer-executable instructions stored thereupon which, when executed by a non-smartphone device, cause the non-smartphone device to:
determine whether the non-smartphone device should be booted using only a desktop operating system, using only a smartphone operating system, or using both the smartphone operating system and the desktop operating system concurrently;
in response to determining that the non-smartphone device should be booted using only the smartphone operating system or using both the smartphone operating system and the desktop operating system concurrently, to cause a virtualization layer to be executed on the non-smartphone device;
in response to determining that the non-smartphone device should be booted using only the smartphone operating system, to cause the smartphone operating system to be executed on the non-smartphone device by using the virtualization layer; and
in response to determining that the non-smartphone device should be booted using both the smartphone operating system and the desktop operating system concurrently, to cause the smartphone operating system to be booted on the non-smartphone device using the virtualization layer, to cause the desktop operating system to be booted on the non-smartphone device using the virtualization layer after the smartphone operating system has been completed booted, and to make functionality provided by the smartphone operating system accessible to a user of the non-smartphone device while the desktop operating system is booting.

16. The computer-readable medium of claim 15, having further computer-executable instructions stored thereupon which, when executed by the non-smartphone device, cause the non-smartphone device to:
determine whether the non-smartphone device is being booted for the first time; and
in response to determining that the non-smartphone device is being booted for the first time, to cause the non-smartphone device to boot the desktop operating system without the use of the virtualization layer and to cause a synchronization agent to be installed in the desktop operating system.

17. The computer-readable medium of claim 16, wherein the synchronization agent is configured to synchronize files and folders accessible to the desktop operating system to a shared location accessible by the smartphone operating system, wherein the smartphone operating system further comprise a second synchronization agent configured to synchronize files and folders accessible to the smartphone operating system to the shared location, and wherein the shared location is accessible to the smartphone operating system when the desktop operating system is not executing and is also accessible to the desktop operating system when the smartphone operating system is not executing.

18. The computer-readable medium of claim 17, having further computer-executable instructions stored thereupon which, when executed by the non-smartphone device, cause the non-smartphone device to execute a power management driver in the smartphone operating system that is configured to provide power management functionality compatible with the non-smartphone device.

19. The computer-readable medium of claim 18, wherein the virtualization layer is configured to perform selective virtualization of hardware of the non-smartphone device for the smartphone operating system.

20. A non-smartphone computing device comprising:
a central processing unit (CPU);
a random access memory (RAM); and
a non-volatile memory having a smartphone operating system and a firmware executable by the CPU stored therein, the firmware comprising instructions which, when executed by the CPU, cause the CPU to determine whether the non-smartphone device should be booted using only a desktop operating system, using only a smartphone operating system, or using both the smartphone operating system and the desktop operating system concurrently, in response to determining that the non-smartphone device should be booted using only the smartphone operating system or using both the smartphone operating system and the desktop operating system concurrently, to cause a virtualization layer to be executed on the non-smartphone device, in response to determining that the non-smartphone device should be booted using only the smartphone operating system, to cause the smartphone operating system to be executed on the non-smartphone device by using the virtualization layer, and in response to determining that the non-smartphone device should be booted using both the smartphone operating system and the desktop operating system concurrently, to cause the smartphone operating system to be booted on the non-smartphone device using the virtualization layer, to cause the desktop operating system to be booted on the non-smartphone device using the virtualization layer after the smartphone operating system has been completed booted, and to make functionality provided by the smartphone operating system accessible to a user of the non-smartphone device while the desktop operating system is booting.
